(19) United States
(12) Patent Application Publication
(10) Pub. No.: US 2026/0229929 A1
(43) Pub. Date: Aug. 6, 2026

(54) A STATOR ASSEMBLY

(71) Applicant: Dyson Technology Limited, Malmesbury, Wiltshire (GB)

(72) Inventors: Christopher James GASKELL, Swindon (GB); Harry Alexander MORLEY, Bristol (GB); Pau MIQUEL MIR, Berlin (DE); Chukwuma Junior IFEDI, Bristol (GB); Yu CHEN, Cheltenham (GB); Mark James HARRIMAN, Bristol (GB); Xiaoxu ZHANG, Bristol (GB); Tuncay CELIK, Malmesbury (GB)

(21) Appl. No.: 19/145,069

(22) PCT Filed: Jan. 26, 2024
(86) PCT No.: PCT/IB2024/050739

§ 371 Date: Jul. 1, 2025

(30) Foreign Application Priority Data
Jan. 27, 2023 (GB) 2301188.5

(51) Int. Cl. H02K 1/14; H02K 3/28; H02K 15/08

(52) U.S. Cl. CPC H02K 1/148; H02K 3/28; H02K 15/08; H02K 2203/12

(57) ABSTRACT

A stator assembly for a brushless permanent magnet motor includes a first, second and third stator core assembly. Each of the first, second and third stator core assemblies include a stator core segment and a coil wound about the stator core segment. Each stator core segment spans an arc length of around 120 degrees. Each coil is wound about the respective stator core segment such that the coil overlies radially inner and radially outer surfaces of the stator core segment. The coils are connected such that the stator assembly comprises a three-phase stator assembly.

### FIELD OF THE INVENTION

The present invention relates to a stator assembly for a brushless permanent magnet motor, and to a brushless permanent magnet motor comprising such a stator assembly.

### BACKGROUND OF THE INVENTION

There is a general desire to improve electric machines, such as brushless motors, in a number of ways. For example, improvements may be desired in terms of size, weight, power density, manufacturing cost, efficiency, reliability, and noise.

### SUMMARY OF THE INVENTION

According to a first aspect of the present invention there is provided a stator assembly for a brushless permanent magnet motor, the stator assembly comprising: first, second and third stator core assemblies, each of the first, second and third stator core assemblies comprising a stator core segment and a coil wound about the stator core segment; wherein each stator core segment spans an arc length of around 120 degrees, each coil is wound about the respective stator core segment such that the coil overlies radially inner and radially outer surfaces of the stator core segment, and the coils are connected such that the stator assembly comprises a three-phase stator assembly.

For a stator assembly of a brushless permanent magnet motor, splitting the stator core into segments may increase a reluctance of the stator assembly in view of the air gaps between stator core segments, thereby providing resistance to magnetic flux attempting to pass between the stator core segments. Furthermore, for each incremental integer increase in the number of segments of the stator core, it may become more challenging to reliably and securely connect the stator core segments together, which can result in variations in global form of the stator assembly. Such variations in form may introduce saliency, which may inhibit production of desirable magnetic torque in a brushless permanent magnet motor.

However, increasing a number of segments may be desirable to facilitate manufacturing of the stator assembly. For example, an increase in number of segments that form an annular stator core may enable the stator core segments to be more linear than if a lower number of segments were utilised to form the annular stator core. This may facilitate formation of laminations that form the stator core segments, for example by enabling an increased number of laminations to be formed from a single sheet of material, reducing material wastage and cost.

Furthermore, an annular core or a two-part core with each segment spanning an arc length of 180 degrees may provide reduced access for a winding machine to the interior of the curve defined by the stator core segment when compared to, for example curves of lower arc length. Stator core segments of lower arc lengths may enable easier and/or less expensive winding processes to be utilised.

The stator assembly according to the first aspect of the present invention has been found to provide a good compromise between the above-mentioned competing factors.

The stator assembly may comprise a slotless stator assembly.

Each of the first, second and third stator core assemblies may comprise first and second coils, such that the stator assembly comprises six coils in total. Use of six coils may provide relatively little radial loading on a rotor assembly associated with the stator assembly in use compared to, for example, an arrangement in which three coils are utilised. The first and second coils may be substantially evenly spaced about a periphery of the stator assembly.

The first and second coils of each respective stator assembly may be wound in opposite directions. As each stator core assembly comprises the same number of coils, with one coil wound in each direction, for example left-hand wound or right-hand wound, the stator core assemblies may be substantially similar in form, which may reduce a cost and/or complexity of a manufacturing process for the stator assembly compared to, for example, a stator assembly where different forms of stator core assembly are used.

The first and second coils of each respective stator assembly may be wound using a single wire, for example using a continuous winding process. This may reduce cost and complexity of manufacture of the stator assembly compared to, for example, a stator assembly where individual wires are used to wind each coil.

Each of the first, second and third stator core assemblies may comprise a respective bobbin, each bobbin comprising first and second connection formations connected to respective second and first connection formations of adjacent ones of the first, second and third stator core assemblies in the stator assembly. Provision of connection formations on the bobbins, rather than on the stator core segments, may reduce reluctance and/or saliency which could otherwise occur due to, for example, variations in shape of the stator core segments due to tolerances of manufacture.

Each of the stator core segments may comprise first and second generally planar end surfaces in contact with respective second and first generally planar end surfaces of adjacent ones of the first, second and third stator core assemblies in the stator assembly. This may reduce reluctance compared to, for example an arrangement where stator core segments have interfaces with more complex geometries, where variations in shape of the stator core segments may occur due to tolerances of manufacture.

The stator assembly may have an outer diameter of no more than 40 mm, for example no more than 35 mm, no more than 30 mm, no more than 25 mm, or no more than 20 mm. Providing three stator core segments each spanning an arc length of around 120 degrees in a stator assembly of such a size may facilitate winding of the coils compared to, for example, an arrangement where a singular annular stator core is provided in a stator assembly of a similar outer diameter.

Each stator core segment may comprise a height greater than its thickness, for example a height greater than its radial extent. Each stator core segment may comprise a stack of laminations.

Each stator core assembly may comprise a same number of termination connections to which the respective coils are connected. This may ensure an even spread of termination connections amongst the stator core assemblies.

Each of first, second and third stator core assemblies may comprise substantially the same form. This may reduce cost and complexity of manufacture of the stator assembly compared to, for example, a stator assembly where different forms of stator core assembly are used.

According to a second aspect of the present invention there is provided a brushless permanent magnet motor comprising a stator assembly according to the first aspect of the present invention.

The coils, when energised, may generate a magnetic field that interacts with a permanent magnet of a rotor assembly of the brushless permanent magnet motor to rotate the rotor assembly relative to the stator assembly.

The brushless permanent magnet motor may be configured to operate at around 400V, for example with the coils configured to receive a DC link voltage of around 400V.

According to a third aspect of the present invention there is provided a haircare appliance comprising a brushless permanent magnet motor according to the second aspect of the present invention.

According to a fourth aspect of the present invention there is provided a vacuum cleaner comprising a brushless permanent magnet motor according to the second aspect of the present invention.

According to a fifth aspect of the present invention there is provided a stator core assembly for a stator core of a brushless permanent magnet motor, the stator core assembly comprising a stator core segment spanning an arc length of around 120 degree, and a coil wound about the stator core segment such that the coil overlies radially inner and radially outer surfaces of the stator core segment.

Optional features of aspects of the present invention may be equally applied to other aspects of the present invention, where appropriate.

### BRIEF DESCRIPTION OF THE DRAWINGS

FIG. 1 is a perspective view of a stator assembly;

FIG. 2 is an exploded view of the stator assembly of FIG. 1;

FIG. 3 is a perspective view of a stator core assembly of the stator assembly of FIG. 1;

FIG. 4 is an exploded view of the stator core assembly of FIG. 3;

FIG. 5 is a perspective view of a first busbar assembly of the stator assembly of FIG. 1;

FIG. 6 is a perspective view of a live busbar of the first busbar assembly of FIG. 5;

FIG. 7 is a perspective view of a neutral busbar;

FIG. 8 is a schematic illustration of a brushless permanent magnet motor comprising the rotor assembly of FIG. 1;

FIG. 9 is a schematic illustration of a vacuum cleaner comprising the brushless permanent magnet motor of FIG. 6; and

FIG. 10 is a schematic illustration of a haircare appliance comprising the brushless permanent magnet motor of FIG. 1.

### DETAILED DESCRIPTION OF THE INVENTION

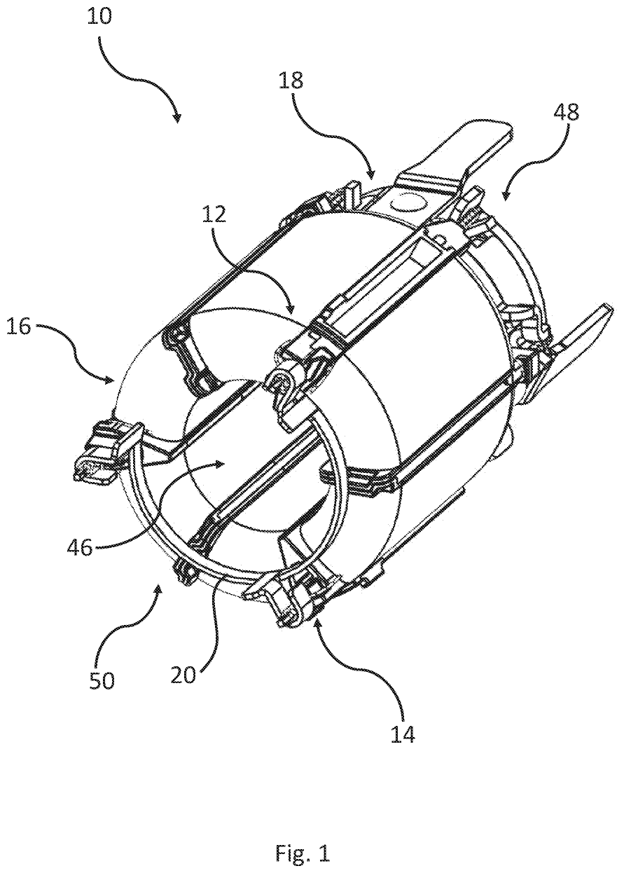

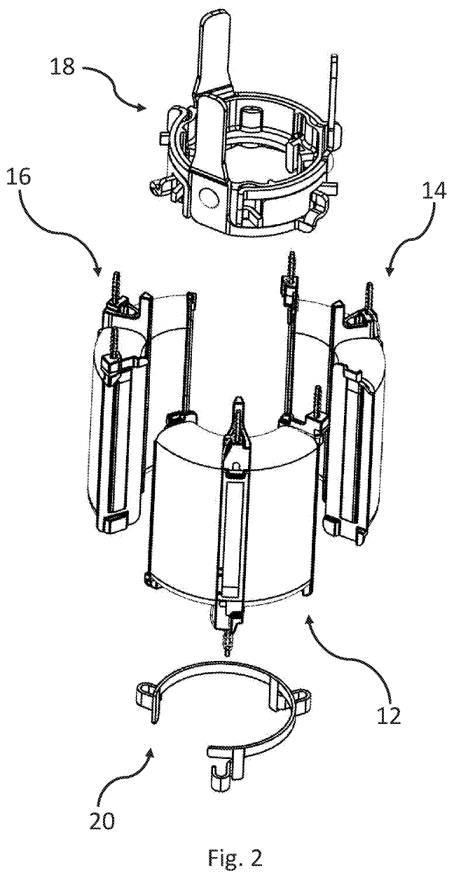

A stator assembly 10 is illustrated schematically in FIGS. 1 and 2, and comprises first 12, second 14 and third 16 stator core assemblies, and first 18 and second 20 busbar assemblies.

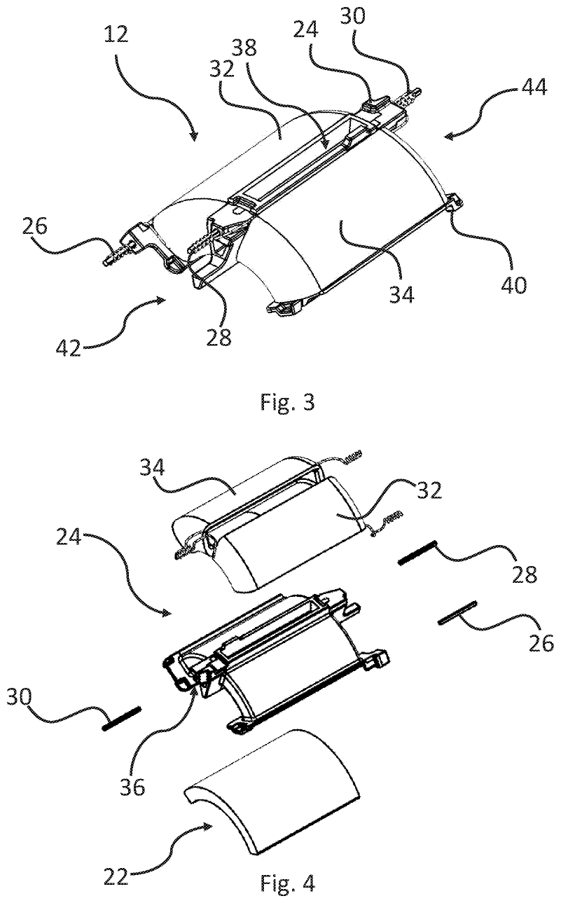

The first stator core assembly is shown in FIGS. 3 and 4. Each of the first 12, second 14, and third 16 stator core assemblies has substantially the same form, and so the second 14 and third 16 stator core assemblies will not be described in detail here for the sake of brevity. It will be appreciated that like reference numerals for features of the first stator core assembly 12 may be used for corresponding features of the second 14 and third 16 stator core assemblies.

The first stator core assembly 12 comprises a stator core segment 22, a bobbin 24, first 26, second 28, and third 30 termination connections, and first 32 and second 34 coils.

The stator core segment 22 is formed of a stack of steel laminations (not shown), and is generally arcuate in form, with a height greater than its length and width. The stator core segment 22 spans an arc length of substantially 120 degrees. Circumferential end faces of the stator core segment 22 are generally planar in form.

The bobbin 24 is formed of a plastics material, and is overmoulded onto the stator core segment 22. The bobbin 24 comprises connection recesses 36, a window 38, and connection features 40. The connection recesses 36 are generally cylindrical in form, and are shaped and dimensioned to receive the respective first through third termination connections 26-30. The window 38 is generally elongate and rectangular in cross-section, and provides line-of-sight to a radially outer face of the stator core segment 22. The window 38 enables an appropriate magnet to hold the stator core segment 22 in place during assembly of the first stator core assembly 12. The connection features 40 comprise appropriate projections and/or recesses that interact with corresponding recesses and/or projections of the second 14 and third 16 stator core assemblies to hold the stator core assemblies 12,14,16 relative to one another.

The first through third termination connections 26-30 have substantially the same form, and are generally elongate pins with a square cross-sectional shape, formed from an electrically conductive material. The first 26 and second 28 termination connections are inserted into respective connection recesses 36 with a push-fit, and extend axially outwardly from a first end 42 of the first stator core assembly 12. The third termination connection 30 is inserted into a respective connection recess 36 and extends axially outwardly from a second end 44 of the first stator core assembly 12 opposite to the first end 42 of the first stator core assembly 12.

The first 32 and second 34 coils are formed from turns of copper wire, and are wound about the bobbin 24 such that the first 32 and second 34 coils overlie radially inner and radially outer surfaces of the stator core segment 22. The stator assembly 10 is a slotless stator assembly. The first 32 and second 34 coils are represented in block form, such that individual turns are not visible, in the figures for the sake of clarity. The first 32 and second 34 coils are formed from a single piece of copper wire, such that the first 32 and second 34 coils are wound using a continuous winding process. For example, the first coil 32 being at the first termination connection 26, is wound about the bobbin 24, and hence the stator core segment 22, and tied off at the third termination connection 30. The second coil 32 then starts at the third termination connection 30, is wound about the bobbin 24, and hence the stator core segment 22, and tied off at the second termination connection 28. The first 32 and second 34 coils are wound in opposite directions, with one of the first 32 and second 34 coils being right-hand wound, and the other of the second 34 and first 32 coils being left-hand wound.

Collectively, the first 12, second 14 and third 16 stator core assemblies, when connected together, define an annulus having a central bore 46 for receiving a rotor assembly, with the stator assembly 10 having a diameter of no more than 40 mm. When connected together the generally circumferential faces of the stator core segments 22 are substantially in contact with one another, such that a generally annular stator core is formed by the stator core segments 22. The first 26 and second 28 termination connections of each stator core assembly 12,14, 16 form a first subset of termination connections located at first end 48 of the stator assembly 10, and the third termination connections 30 form a second subset of termination connections located at a second end 50 of the stator assembly 10. The first 26 and second 28 termination connections are evenly spaced about a circumference of the first end 48 of the stator assembly 10, whilst the third termination connections 30 are evenly spaced about a circumference of the second end 50 of the stator assembly 10.

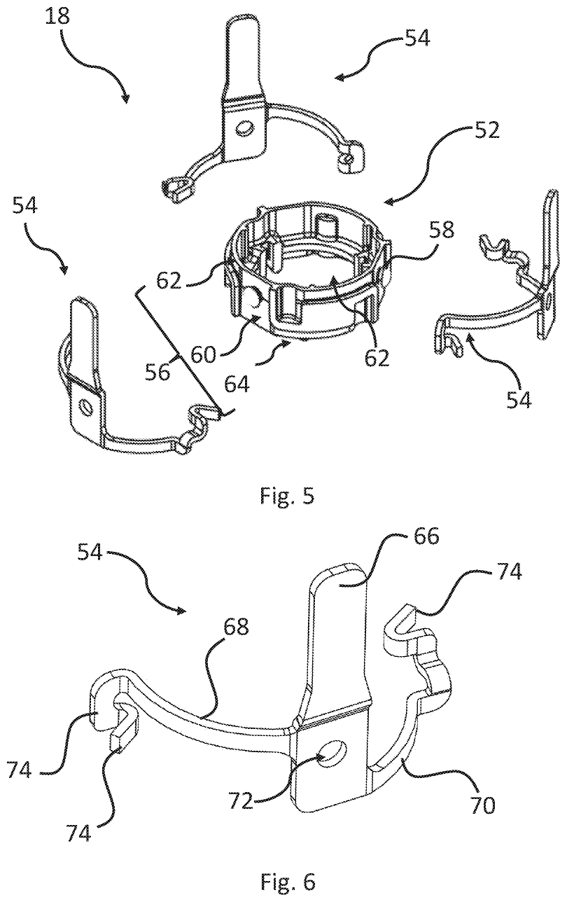

The first busbar assembly 18 is located at the first end 48 of the stator assembly 10, and is shown in isolation in FIG. 5. The first busbar assembly 18 comprises a carrier 52 and three live busbars 54.

The carrier 52 is generally annular in form, and is moulded from a plastics material. The carrier 52 comprises three channels 56 and three heat stakes 58. Each channel 56 has substantially the same form, is formed on a radially outer surface of the carrier 52, and has a central portion 60, an upper portion 62, and a lower portion 64. The central portion 60 extends axially along the carrier 52 in a height direction, whilst the upper portion 62 extends circumferentially from the central portion 60 in a first direction, and the lower portion 64 extends circumferentially from the central portion 60 in a second direction opposite to the first direction. The upper portion 62 of one channel 56 overlies a lower portion 64 of an adjacent channel 56 on the carrier 52. Each heat stake 58 is located in a corresponding central portion 60 of a channel 56.

A live busbar 54 is illustrated in isolation in FIG. 6. The live busbar 54 is formed of an electrically conductive material, and comprises a central portion 66, an upper portion 68, and a lower portion 70. The central portion 66 extends axially in a height direction, whilst the upper portion 68 extends circumferentially from the central portion 66 in a first direction, and the lower portion 70 extends circumferentially from the central portion 66 in a second direction opposite to the first direction. The central portion 66 defines a connection of the stator assembly 10 to an inverter (not shown), e.g. a live connection of the stator assembly that can receive a voltage in use. The central portion 66 comprises an aperture 72 for receiving a corresponding heat stake 58 of the carrier 52.

Each of the upper portion 68 and the lower portion 70 comprises connecting arms 74 extending in a direction parallel to the height of the central portion 66. The connecting arms 74 are substantially evenly spaced away from the central portion 66. The connecting arms 74 are welded to the first 26 and second 28 termination connections of each stator core assembly 12,14, 16 at the first end 48 of the stator assembly 10. Each live busbar 54 is thereby connected to two coils of the stator assembly.

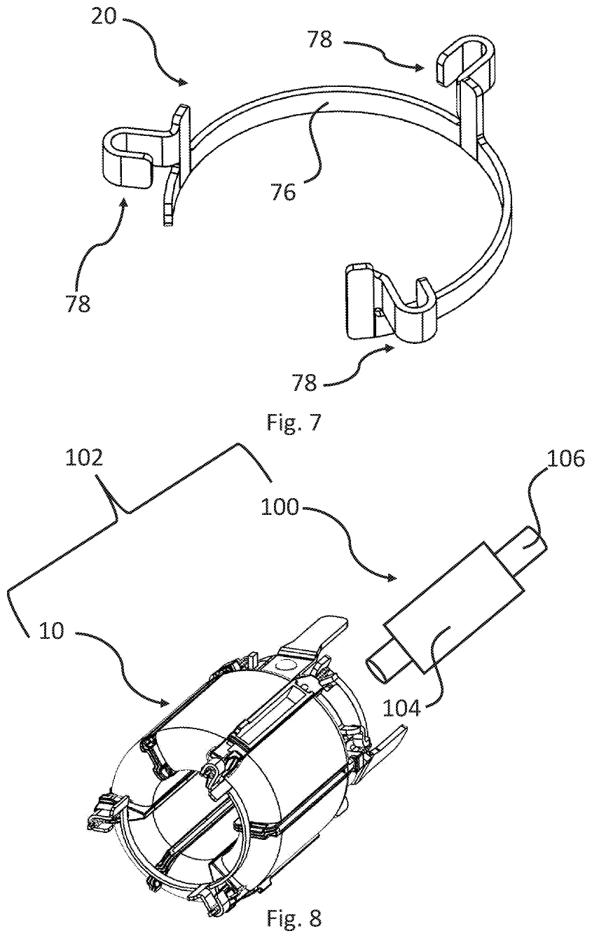

The second busbar assembly 20 is located at the second end 50 of the stator assembly 10, and is shown in isolation in FIG. 7. The second busbar assembly 20 comprises a single neutral busbar having a main body 76 and three connecting arms 78. The main body 76 is arcuate in form, and the three connecting arms 78 extend from the main body 76. The connecting arms 78 are welded to the third termination connections 30 of each stator core assembly 12,14,16 at the second end 50 of the stator assembly 10. Given that the first 32 and second 34 coils of each stator core assembly 12,14,16 are connected to the third termination connection 30 of that particular stator core assembly 12,14, 16, and that a single neutral busbar is used to connect the third termination connections 30 together, each first 32 and second 34 coil of the stator assembly is connected together by the second busbar assembly 20.

In the manner described above, the coils 32,34 and the first 18 and second 20 busbar assemblies define a three-phase parallel star connection, with the first 26 and second 28 termination connections acting as live connections, and the third termination connections 30 acting as neutral connections.

Locating the first 26 and second 28 termination connections at an opposite end of the stator assembly 10 to the third termination connections 30 may enable the stator assembly 10 to have a smaller radial and/or axial dimension in comparison to a stator assembly in which the termination connections are located at a single end of the stator assembly. By minimising a radial and/or axial dimension of the stator assembly, a size of a brushless permanent magnet motor comprising the stator assembly 10 may be minimised, which may provide for a minimised packaging volume for the brushless permanent magnet motor within an appliance.

Furthermore, locating the termination connections at opposing ends of the stator assembly 10 in the manner described above may facilitate manufacture of the stator assembly 10 by providing greater space for ease of access to the termination connections in comparison to an arrangement where all termination connections are located at a single end of the stator assembly 10.

Manufacture of the stator assembly 10 may further be facilitated by use of the three stator core segments 22, each spanning an arc length of substantially 120 degrees. In particular, splitting the stator core into segments may enable the stator core segments 22 to be more linear than if a lower number of segments were utilised to form the annular stator core. This may facilitate formation of laminations that form the stator core segments 22, for example by enabling an increased number of laminations to be formed from a single sheet of material, reducing material wastage and cost.

Furthermore, an annular core or a two-part core with each segment spanning an arc length of 180 degrees may provide reduced access for a winding machine to the interior of the curve defined by the stator core segment when compared to, for example curves of lower arc length. Stator core segments of lower arc lengths may enable easier and/or less expensive winding processes to be utilised.

In use, the stator assembly 10 is paired with a rotor assembly 100 to form a brushless permanent magnet motor 102, as illustrated schematically in FIG. 8. The rotor assembly 102 comprises a shaft 104 and a permanent magnet 106 mounted to the shaft 104. When the coils 32,34 are driven with an appropriate voltage, here of up to around 400V, the stator assembly 10 generates a magnetic field that interacts with the permanent magnet 106 to rotate the rotor assembly 100.

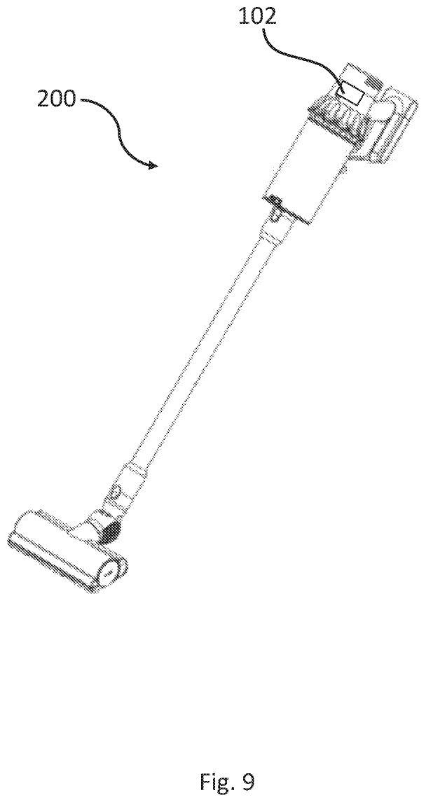

A vacuum cleaner 200 comprising the brushless permanent magnet motor 102 is illustrated schematically in FIG. 9.

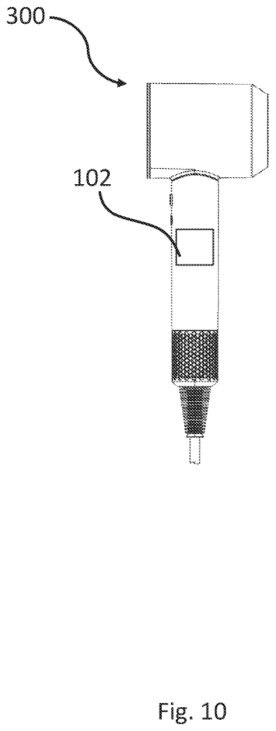

A haircare appliance 300 comprising the brushless permanent magnet motor 102 is illustrated schematically in FIG. 10.

1. A stator assembly for a brushless permanent magnet motor, the stator assembly comprising:
a first, second and third stator core assembly, each of the first, second and third stator core assemblies comprising a stator core segment and a coil wound about the stator core segment;
wherein each stator core segment spans an arc length of around 120 degrees, each coil is wound about the respective stator core segment such that the coil overlies radially inner and radially outer surfaces of the stator core segment, and the coils are connected such that the stator assembly comprises a three-phase stator assembly.

2. A stator assembly as claimed in claim 1, wherein each of the first, second and third stator core assemblies comprises a first and second coil, such that the stator assembly comprises six coils in total.

3. A stator assembly as claimed in claim 2, wherein the first and second coils of each respective stator assembly are wound in opposite directions.

4. A stator assembly as claimed in claim 2, where the first and second coils of each respective stator assembly are wound using a single wire.

5. A stator assembly as claimed in claim 1, wherein each of the first, second and third stator core assemblies comprises a respective bobbin, each bobbin comprising a first and second connection formation connected to respective second and first connection formations of adjacent bobbins of the first, second and third stator core assemblies in the stator assembly.

6. A stator assembly as claimed in claim 1, wherein each of the stator core segments comprise a first and second generally planar end surface in contact with respective second and first generally planar end surfaces of adjacent stator core segments of the first, second and third stator core assemblies in the stator assembly.

7. A stator assembly as claimed in claim 1, wherein the stator assembly has an outer diameter of no more than 40 mm.

8. A stator assembly as claimed in claim 1, wherein each stator core assembly comprises a same number of termination connections to which the respective coils are connected.

9. A stator assembly as claimed in claim 1, wherein each of the first, second and third stator core assemblies comprises substantially the same form.

10. A brushless permanent magnet motor comprising a stator assembly as claimed in claim 1.

11. A haircare appliance comprising a brushless permanent magnet motor as claimed in claim 10.

12. A vacuum cleaner comprising a brushless permanent magnet motor as claimed in claim 10.

13. A stator core assembly for a stator core of a brushless permanent magnet motor, the stator core assembly comprising a stator core segment spanning an arc length of around 120 degrees, and a coil wound about the stator core segment such that the coil overlies radially inner and radially outer surfaces of the stator core segment.
